(19) United States
(12) Patent Application Publication
(10) Pub. No.: US 2015/0206139 A1
(43) Pub. Date: Jul. 23, 2015

(54) TWO DEVICE AUTHENTICATION MECHANISM

(71) Applicant: HIGHGATE LABS LIMITED, London (GB)

(72) Inventor: Edward Lea, London (GB)

(21) Appl. No.: 14/417,372

(22) PCT Filed: Jul. 26, 2013
(86) PCT No.: PCT/GB2013/052020

§ 371 Date: Jan. 26, 2015

Related U.S. Application Data
(60) Provisional application No. 61/676,019, filed on Jul. 26, 2012.

(30) Foreign Application Priority Data
Jul. 26, 2012 (GB) 1213277.5

(51) Int. Cl. G06Q 20/40; G06Q 20/36; H04L 29/06

(52) U.S. Cl. CPC G06Q 20/40; H04L 63/0807; G06Q 20/367

(57) ABSTRACT

The present invention relates to method for authenticating a user. The method includes the steps of: a second user device requesting authentication from a third party server; the third party server requesting an authentication token from a gateway server; the gateway server generating a transaction ID and transmitting an authentication token to the second user device, wherein the authentication token incorporates the transaction ID; the second user device outputting the authentication token; a first user device receiving the outputted authentication token; the first user device transmitting an authentication request to an application server, wherein the request includes the transaction ID extracted from the authentication token and a user identifier; and the application server verifying the authentication request and authenticating the user. A system for authenticating a user comprising two user devices and a server is also described.

### FIELD OF INVENTION

The present invention is in the field of authentication. More particularly, but not exclusively, the present invention relates to online authentication mechanisms.

### BACKGROUND

In the modern world, individuals often need to authenticate themselves when using online services, such as payment services or to gain access.

Current common methods for authentication involve a user entering a user-name and password within a browser on a computer or mobile device which communicates with a web service via HTTPS. These methods can be augmented by the browser or client-side software “remembering” user-names and/or passwords to assist the user in re-authentication.

More secure methods utilise two-factor authentication. The first factor is the username and/or password known by the user and the second factor is a physical security token in the possession of the user. A common security token, as used by RSA Security's SecurID system, displays a new number at set intervals. The authentication server for the SecurID system has information about the sequence of numbers and can verify the number entered by the user from the SecurID.

These existing methods have various disadvantages. For example, if the website has been compromised, the user can be providing their secret authentication information to an unauthorised party. Furthermore, the use of two-factor authentication requires the user to carry with them a security token.

Furthermore, the usernames and passwords created by users are often guessable.

Accordingly, there is a desire for a more secure authentication system.

Online payment systems currently fall into one of two categories. They either require the user to enter all their payment card, billing and delivery details every time a user makes a payment, or the merchant stores the details but requires a username and password from the user.

Processes falling in the former category are time consuming and error-prone that can result in online merchants losing a significant amount of revenue. It can also discourage users from making a payment.

Where usernames and passwords are required this obviously suffers the same disadvantages as current authentication methods.

There are alternative payment services, such as PayPal, which store payment credentials centrally. However, username and password pairs also protect these. Digital wallet services, such as VISA's v.me service, also offer the ability to store payment card details centrally. These services not only require a username and password to use but also share all of the payment card details with a merchant. This requires the user to implicitly trust both the digital wallet and also the merchant.

There is a desire for an improved authentication method which is suitable for use with payment services.

It is an object of the present invention to provide an authentication mechanism which overcomes the disadvantages of the prior art, or at least provides a useful alternative.

### SUMMARY OF INVENTION

According to a first aspect of the invention there is provided a method for authenticating a user using a first and second user device, the method including:
a) the second user device requesting authentication from a third party server;
b) the third party server requesting an authentication token from a gateway server;
c) the gateway server generating a transaction ID and transmitting an authentication token to the second user device, wherein the authentication token incorporates the transaction ID;
d) the second user device outputting the authentication token;
e) the first user device receiving the outputted authentication token;
f) the first user device transmitting an authentication request to an application server, wherein the request includes the transaction ID extracted from the authentication token and a user identifier; and
g) the application server verifying the authentication request and authenticating the user.

According to another aspect of the invention there is provided a system for authenticating a user, including:

a gateway server configured to receive a request for an authentication token from a third party server, to generate a transaction ID and to transmit an authentication token to the second user device, wherein the authentication token incorporates the transaction ID;
an application server configured to verify the authentication request and authenticate the user;
a first user device configured to receive the outputted authentication token and to transmit an authentication request to an application server, wherein the request includes the transaction ID extracted from the authentication token and a user identifier; and
a second user device configured to request authentication from a third party server and to output the authentication token.

Other aspects of the invention are described within the claims.

### BRIEF DESCRIPTION OF THE DRAWINGS

Embodiments of the invention will now be described, by way of example only, with reference to the accompanying drawings in which:

FIG. 1: shows a system in accordance with an embodiment of the invention;

FIG. 2: shows a method in accordance with an embodiment of the invention;

FIG. 3: shows a user identity creation method for use with a payment service;

FIG. 4: shows a block diagram illustrating communication flow within an authentication system using the user identity creation method and an authentication mechanism in accordance with an embodiment of the invention;

FIG. 5: shows a block diagram illustrating communication flow within a payment system using the user identity creation method and an authentication mechanism in accordance with an embodiment of the invention; and

FIG. 6: shows a flow diagram illustrating a payment method within the above payment system.

### DETAILED DESCRIPTION OF PREFERRED EMBODIMENTS

The present invention provides a two-“user device” authentication mechanism.

The invention utilises a server to coordinate communication between a first and second device both in use by the user to authenticate the user.

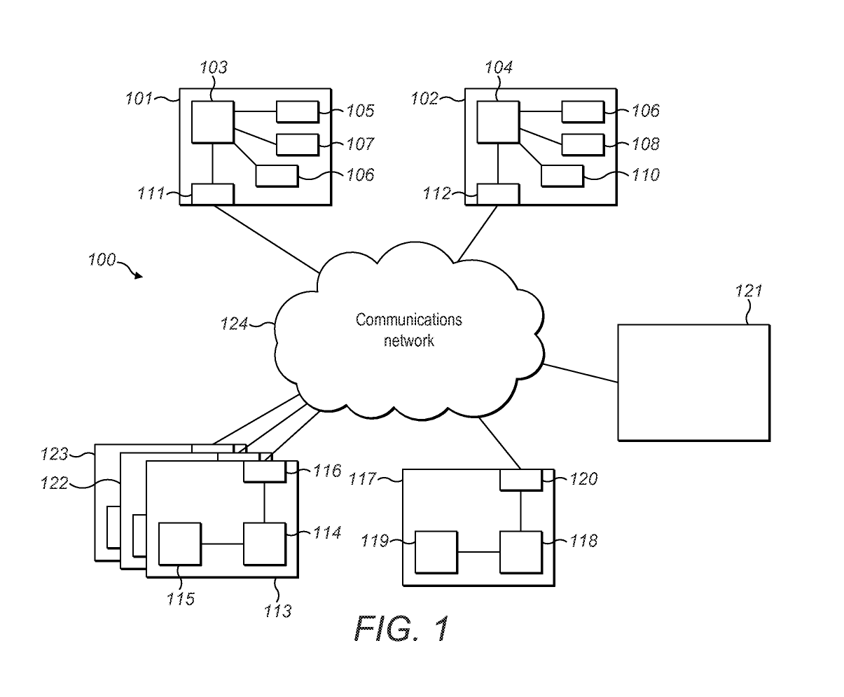

In FIG. 1, a system 100 in accordance with an embodiment of the invention is shown.

The system 100 includes a first user device 101, such as a mobile computing device (i.e. a smart-phone or tablet computer). A second user device 102, such as a computing device (i.e. a computer or laptop) is also shown.

Both user devices 101, 102 may include a processor 103, 104, a memory 105, 106, an input 107, 108, an output 109, 110, and a communications module 111, 112.

The system 100 also includes an application server 113. The application server 113 may include a processor 114, a memory 115, and a communications module 116. The system 100 may also include an authentication gateway server 117. The gateway server 117 may include a processor 118, a memory 119, and a communications module 120.

A third party server 121 is also shown.

The authentication gateway server 117 is configured to communicate with the third party server 121 and the second user device 102.

The system 100 may include a plurality of application servers 113, 122, 123. The authentication gateway server 117 may be further configured to select an application server 113 from the plurality of application servers 113, 122, 123 based upon load and to route requests from third party servers 121 to the selected application server 113.

The first user device 101 is configured to communicate with the application server 113. The communication is via a communications network 124 such as mobile Internet.

The second user device 102 is configured to communicate with the third party server 121. The communication is via a communications network 124 such as the Internet. The second user device 102 may be configured to transmit requests for authentication to the third party server 121, to receive an authentication token and to output the token via the output 110. The output 110 may be a display device.

The third party server 121 may be configured to receive the authentication requests from the second user device 102 and to generate a request for an authentication token from the gateway server 117 in response. The third party server 121 may also be configured for generating a one-time nonce and including it with the request, and using it to prevent re-use of existing transactions.

The gateway server 117 may be configured to receive a request for an authentication token from a third party server 121, to generate a transaction ID and to transmit an authentication token, incorporating the transaction ID, to the second user device 102.

The first user device 101 may be configured to receive the token from the second user device 102, for example, by using a visual input means 106 (such as a camera or scanner) to capture the displayed token. The first user device 101 may be configured to extract a transaction ID from the token, to generate and sign an authentication request comprising the transaction ID and a user identifier, and to transmit the request to the application server 113.

The application server 113 may be configured to receive the authentication request from the first user device 101, and to verify the request and authenticate the user by mapping the user identifier to a stored public key and checking the signature of the request.

It will be appreciated that a combination gateway/application server may perform the functions of both the application server 113 and gateway server 117.

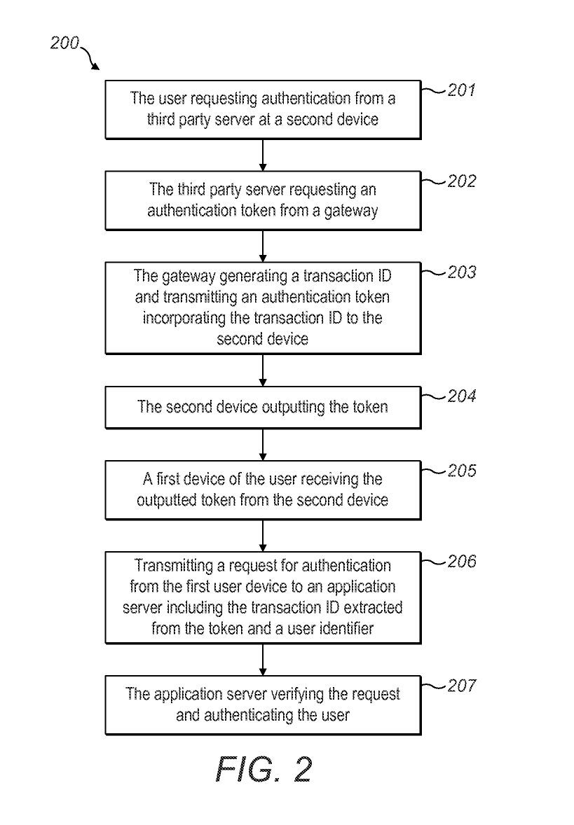

In FIG. 2, a method 200 in accordance with an embodiment of the invention is shown.

The user may access a website at the third party server using the second user device.

The website may display a web-page within a web browser at the second user device comprising an action for the user such as “Authenticate”.

When the action is actuated by the user a request is transmitted to the third party server in step 201. The third party server, in turn, transmits a request to the authentication gateway in step 202. The authentication gateway generates a unique transaction ID, an authentication token, and a location (such as a URL) for the authentication token in step 203.

The location for the authentication token may not be at the third party server. A possible advantage for this may be that the third party server is not privy to the authentication token.

Also in step 203, the location for the authentication token is transmitted to the second user device which accesses the location and, in step 204, displays the authentication token at the second user device.

The second location may be accessed within a web browser at the second user device. The second location may be displayed within an overlay on a web-page from the third party server. The overlay may be, for example, an iframe. A possible advantage for this is that cross-site scripting security restrictions within the web browser may be complied with without the third party server requiring access to the authentication token.

The authentication token may be encoded and presented via a QR code. It will be appreciated that other graphically encoded mechanisms may be used such as 2D barcodes. In one embodiment, the token is encoded in a non-graphical format which will be described later.

The request may include a one-time nonce and additional information. The additional information may relate to further activity to be undertaken by the application server on behalf of the third party server.

The user uses the first user device to receive the authentication token from the second user device in step 205. For example, where the authentication token is a QR code, the user may use a visual capture device (such as a built in camera) at the first user device to capture an image of the QR code displayed on a screen of the second user device.

In an alternative embodiment, the authentication token may be a code which is displayed on the second user device and entered by the user at the first user device. In a yet further alternative embodiment, the authentication token may be outputted by the second user device using a short-range transmission method, such as Bluetooth, NFC (near field communications), or any other short range method, and received by the first user device.

The first user device generates a request incorporating transaction ID information extracted from the QR code and an identifier of the user, digitally signs the request and transmits the request to the application server in step 206.

The identifier may be an email address. In one embodiment, the application server uses a table of user identifiers to user identifiers for specific third party services. The application server may then select the appropriate identifier for the user for the third party server and replace the received identifier with the mapped identifier for the remainder of the method.

The application server receives the request and verifies the signature in step 207. If verified, the application server then forwards the identifier and the transaction ID in the request to the authentication gateway server.

The authentication gateway server uses the transaction ID to retrieve the nonce and transmits the user identifier and the nonce to the third party server.

The third party server may verify the one-time nonce to confirm it has not been used and may confirm authentication of the user.

In one embodiment, once the application server authenticates the user it may utilise additional information to undertake activities on behalf of the third party server and user. For example, it may act as a payment facilitator using stored details about the user to authorise payment to a merchant of the third party server.

In one embodiment, an identity generation method may include the first user device transmitting a first request, including a user identifier (such as a username or email address), to the application server.

The application server may generate an authentication token associated with the user identifier and transmit that token for receipt by an address (such as an email address) associated with the user.

The first user device may receive the authentication token via the address of the user.

The first user device may create a second request by encrypting at least a part of the authentication token and transmit the request to the application server.

The application server may decrypt the second request to verify the request and validate the user identifier as an identity for the user.

The user device and application server may use a shared secret to encrypt/decrypt the authentication token, or a public/private key pair or pairs.

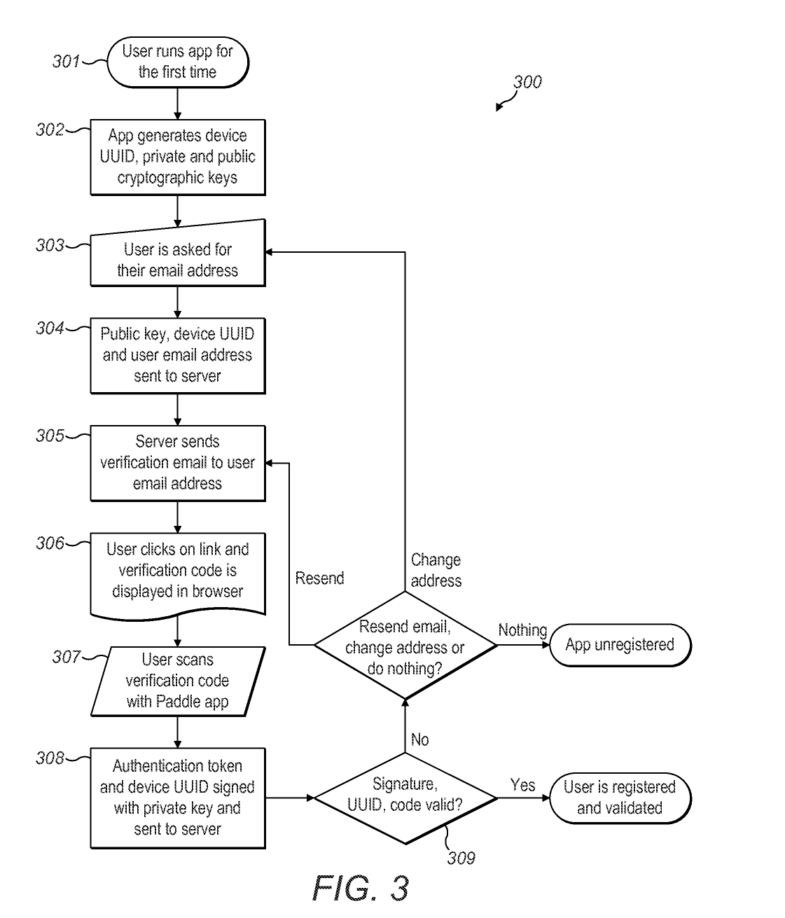

Another identity generation method will now be described with reference to FIG. 3.

In this system that this method 300 is used within, the first user device is a smart phone and the second user device is a computing device executing a web browser.

The server in this example will be referred to as a Paddle server.

In step 301, the user installs a dedicated app on their smart phone, by downloading from an app store or similar, and executes it for the first time.

In step 302, during first execution, the app initialises in a base-state with no identity information. The app on the first device then generates a UUID and an RSA public/private key pair. These are all stored securely on the first device, preferably using hardware encryption. It will be appreciated that other public/private key systems can be used, such as DSA (Digital Signature Algorithm).

In step 303, the app prompts the user to enter their email address to be associated with the newly created UUID.

In step 304, the UUID, public key and email address are all sent to the Paddle server.

In step 305, all the submitted information is stored in a database and an authentication token is generated on the Paddle server and stored in the database linked to the UUID. The Paddle server then sends an email to the provided email address that includes a URL to a validation page that includes the authentication token encoded in a OR code.

In step 306, the user opens the email and loads the URL in their desktop web browser.

In step 307, using the same smart phone app on the same smart phone, the user scans the displayed QR code. The smart phone app decodes the QR and extracts the authentication token.

In step 308, the smart phone app makes a request to the Paddle server; the request including the authentication token and UUID. A hash of the request signed with the private key is also transmitted to the Paddle server.

In step 309, the Paddle server checks that the signature is valid using the public key associated with the UUID; it also checks that the authentication token matches the one generated in step 5. If both match, the system can confirm that the user has full control over the email address provided in step 3, and can thus validate the identity of the user.

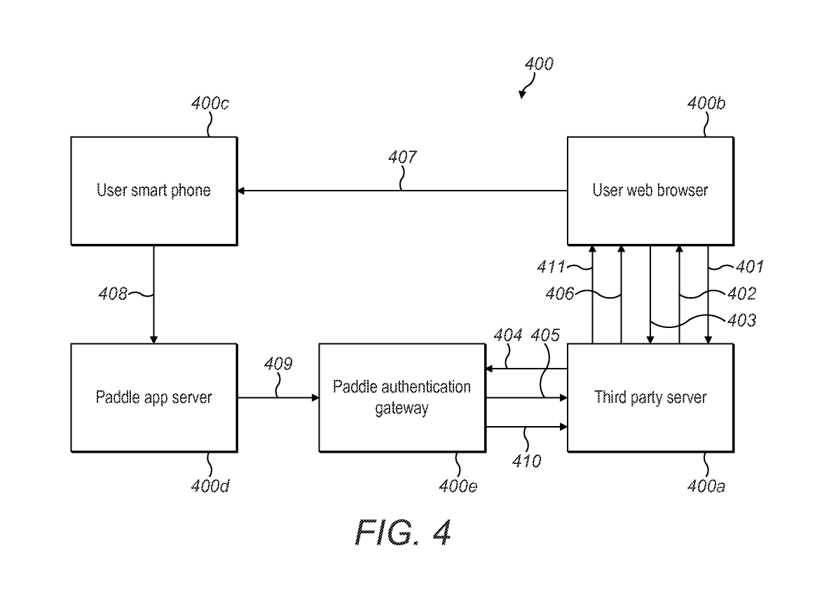

With reference to FIG. 4, an authentication system 400 and method in accordance with an embodiment of the invention will be described.

In this embodiment, the authentication system 400 will be referred to as Paddle.

The authentication system 400 includes a Paddle client library which may be a Javascript library and which may be stored on a third party server 400a. In alternative embodiments, the Paddle client library may be stored on an authentication gateway, an application server, or another party server, such as Amazon S3.

The user is executing a browser on a computing device 400b connected to the Internet. The user also has a smart-phone 400c.

The user may have generated an identity within the system 400 using the identity generation method on their smart-phone 400c described in relation to FIG. 3. In this case, the smart-phone 400c may store a private key which will be used to sign requests and the Paddle application server 400d may store the public key which will be used to verify signed requests. A Paddle authentication gateway 400e may be used to shuttle requests to and from the Paddle application server 400d and the third party server 400a.

It will be appreciated that the Paddle application server 400d and Paddle authentication gateway 400e may be the same server or device.

In step 401, the user requests a page from third party web server 400a within their browser 400b.

In step 402, the page is returned to the browser 400b, including the Paddle client library (for example, an inline script within the HTML), or a reference to it so that the browser 400b can load it into the page (for example, a URL to the library), and a HTTP session cookie.

In step 403, the user clicks on “Login with Paddle” button displayed within the page in the browser 400b.

In step 404, the third party web server 400a generates a one-time token (a nonce) and sends this and the session cookie information to a Paddle authentication gateway 400e. These details are stored and a unique transaction ID is generated at the gateway 400e.

In step 405, the Paddle authentication gateway 400e selects a Paddle application server 400d and sends back a URL for a page containing Paddle application server 400d details and transaction ID (for example, https://test.paddle.to/2e0sdf9gkssdf897bsf, where “test.paddle.to” represents the server details and “2e0sdf9gkssdf897bsfg” represents the transaction ID). The page itself may contain the transaction ID encoded in a QR code.

In step 406, the URL is sent back to the browser 400b and the Paddle client library requests the page at the URL. The Paddle application server sends an HTML page to the browser 400b, in response to the request, that includes a QR code with the transaction ID encoded; this is displayed in the overlay.

In step 407, the user scans QR code with a smart phone mobile application (app).

In step 408, the smart phone 400c app makes a signed request, including the transaction ID, to the correct Paddle application server 400d.

In step 409, the Paddle application server 400d verifies the signature; the request is rejected if the signature is invalid. If it is valid, the email address for this user and the transaction ID is sent back to the Paddle authentication gateway 400e.

In step 410, the Paddle authentication gateway 400e uses the transaction ID to retrieve the stored session details and nonce and sends these, with the user's email address to the third party server 400a.

The third party server 400a verifies the nonce to ensure this request has not been made before and marks the session cookie for this user as authenticated.

In step 411, the web browser 400b is instructed to reload by the Paddle client library and the user sees a “logged in” page.

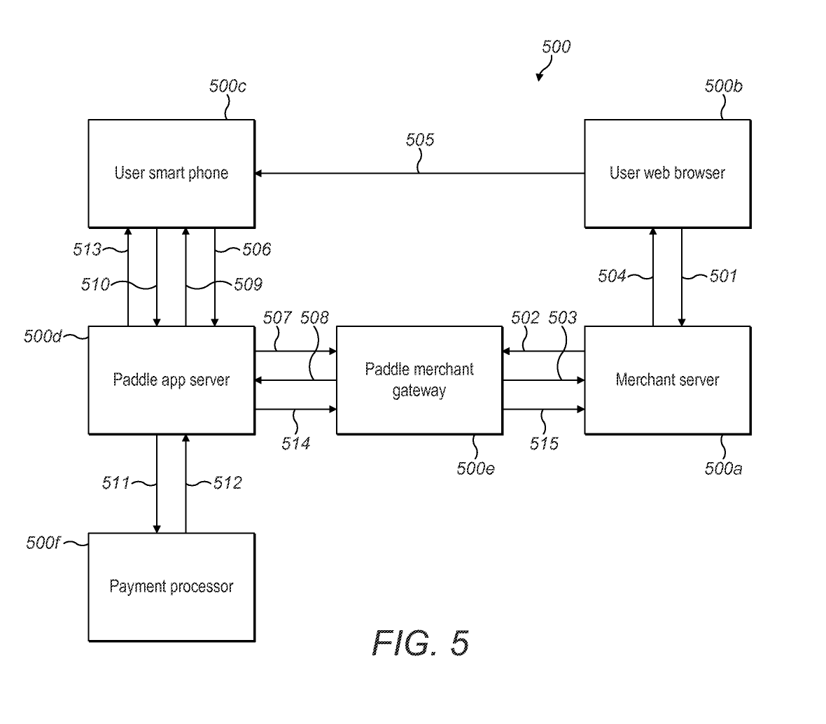

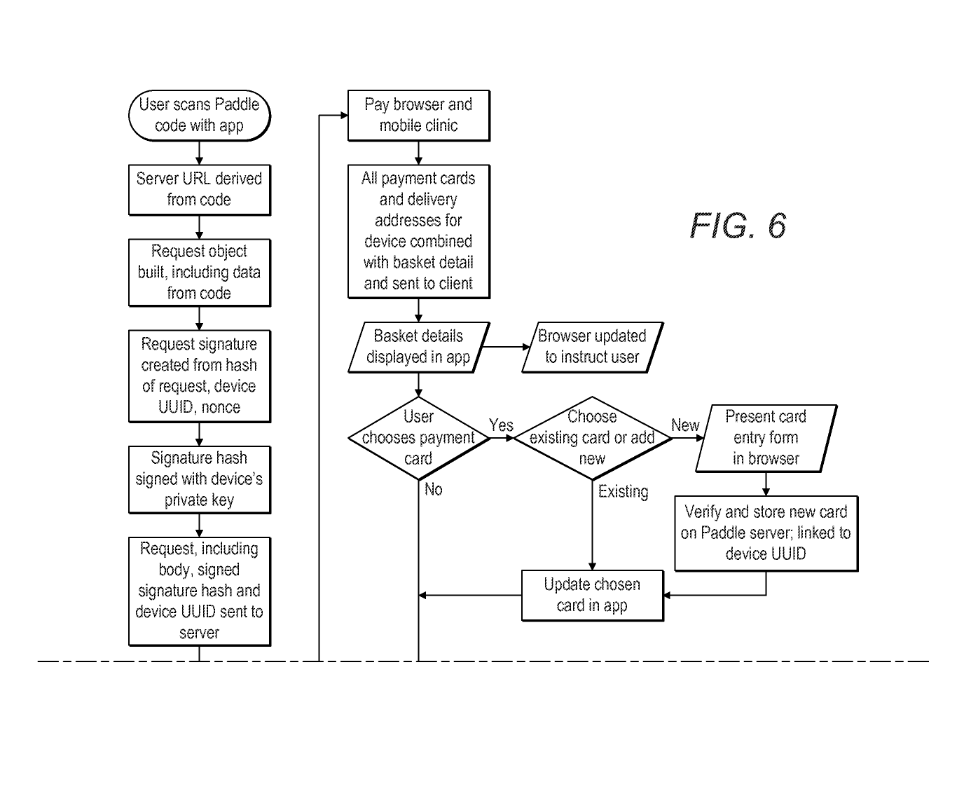

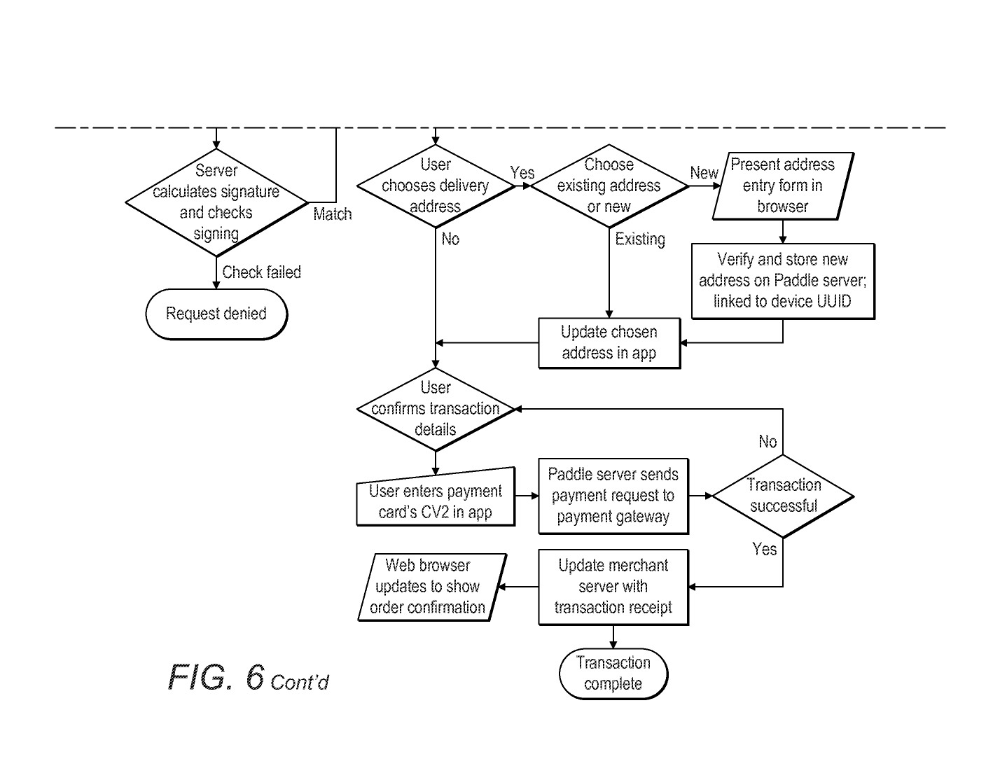

With reference to FIGS. 5 and 6, a payment system 500 utilising an authentication mechanism of an embodiment of the invention will be described.

In this embodiment, the authentication mechanism will be referred to as Paddle.

The authentication mechanism includes a Paddle client library which may be a Javascript library and which may be stored on a merchant server 500a. In alternative embodiments, the Paddle client library may be stored on an authentication gateway, an application server, or another party server, such as Amazon S3.

The user is executing a browser on a computing device 500b connected to the Internet. The user also has a smart-phone 500c.

The user may have generated an identity within the system using the identity generation method on their smart-phone 500c described in relation to FIG. 3. In this case, the smart-phone 500c may store a private key which will be used to sign requests and the Paddle application server 500d may store the public key which will be used to verify signed requests.

A Paddle merchant gateway 500e coordinates communication between the Paddle application server 500d and the merchant server 500a. A third party payment processor 500f receives payment instructions directly from the Paddle application server 500d.

It will be appreciated that the Paddle application server 500d and Paddle merchant gateway 500e may be the same server or device.

The user requests a page from a merchant website 500a.

The page, including the Paddle client library (for example, an inline script within the HTML) or a reference to it so that the browser 500b can load it into the page (for example, a URL to the library), is returned to the browser 500b of the user by a merchant server 500a hosting the website.

The user clicks the “Pay with Paddle” button provided by the client library within the browser 500b. This generates a request, in step 501, to the merchant server 500a.

The merchant server 500a sends transaction details (for example, the merchant's identity, transaction value/amount, currency, a session identifier or other unique reference as determined by the merchant, a nonce and/or timestamp, a URL to submit successful transaction details to later and a URL to direct the user to when a transaction has been completed) to a Paddle merchant gateway 500e in step 502; the details are stored and a unique transaction ID is generated.

The Paddle merchant gateway 500e selects a Paddle application server 500d and sends back to the merchant server 500a, in step 503, a URL to a page containing application server details and the transaction ID (for example, https://server-123.paddle.to/?transactionID=we9sdf80987dcz, where “server-123.paddle.to” represents the server details and where “we9sdf80987dcz” represents the transaction ID).

In step 504, the URL is sent back to browser 500b and the Paddle client library displays it as an overlay. The overlay is loaded from the Paddle App Server 500d selected in step 503 and takes the form of an HTML page, including a QR code that includes the server's public DNS name and the transaction ID.

In step 505, a smart phone app on the user's smart-phone 500c scans the QR code displayed within the browser 500b and decodes the address of server 500d and transaction ID.

In step 506, the smart phone app 500c makes a signed request, including the transaction ID to the decoded Paddle application server 500d.

The Paddle application server 500d verifies the signature; the request is rejected if the signature is not valid. If the signature is valid, transaction details are retrieved from the merchant gateway 500e in step 507.

In step 508, the transaction details are transmitted from the merchant gateway 500e to the Paddle application server 500d. The merchant's bank account details, or credentials with their payment processor, are also transmitted.

In step 509, the transaction details, as well as payment cards stored by the system (for example, the details may be stored at the application server or a central database) for the user and stored delivery details for the user, are sent back to the smart phone app 500c.

Using the smart phone app 500c, the user selects which payment card to use and confirms purchase by providing the payment card's CV2/CVV security number. The CV2/CVV, selected card, selected delivery address and transaction ID are signed and returned to the Paddle application server 500d in step 510.

This signature is verified by the Paddle application server 500d and a payment request is made to a payment processor 500f in step 511. The request includes the amount to be paid, the user's full payment card and billing details, the card's CV2/CVV number and the merchant account for the funds to be deposited to. The payment processor 500f may be selected from a list of payment processors 500f, and may be selected based upon a stored association between the payment processor and the merchant.

In step 512, the payment processor 500f confirms to the Paddle application server 500d that the transaction has been made.

In step 513, the Paddle application server 500d updates the smart phone app 500c to indicate that the transaction has been successful.

In step 514, the Paddle application server 500d sends the payment processor's 500f confirmation of the transaction and user's selected delivery details to the merchant gateway 500e.

In step 515, the merchant gateway 500e confirms to the merchant server 500a that payment has been received and provides delivery details to allow the order to be fulfilled. It also provides the full response from the Payment Processor 500f so that the merchant can register the order as if they had made the payment request directly.

It will be appreciated by those skilled in the art that embodiments of the invention described above may be implemented within hardware components, within software components, or as a mixture of both hardware and software components. It will be appreciated that the software components may be stored within a medium.

Potential advantages of some embodiments of the present invention is that it provides a more secure and convenient alternative to usernames and passwords, it provides a mechanism to authenticate with third parties such as to pay merchants online without sharing any authentication details such as payment card details with them, and it enables frictionless online payments.

Another potential advantage of some embodiments of the present invention is that it enables authentication without the user typing anything. Therefore, in a hostile environment, there is no risk of key interceptors (“key-loggers”) stealing account details.

Another potential advantage of some embodiments of the present invention is that the authentication token is not exposed to the third party server but web browser cross-site security restrictions are maintain.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art.

Therefore, the invention in its broader aspects is not limited to the specific details, representative apparatus and method, and illustrative examples shown and described. Accordingly, departures may be made from such details without departure from the spirit or scope of applicant's general inventive concept.

1. A method for authenticating a user using a first and second user device, including:
a) the second user device requesting authentication from a third party server;
b) the third party server requesting an authentication token from a gateway server;
c) the gateway server generating a transaction ID and transmitting an authentication token to the second user device, wherein the authentication token incorporates the transaction ID;
d) the second user device outputting the authentication token;
e) the first user device receiving the outputted authentication token;
f) the first user device transmitting an authentication request to an application server, wherein the request includes the transaction ID extracted from the authentication token and a user identifier; and
g) the application server verifying the authentication request and authenticating the user.

2. A method as claimed in claim 1, wherein the authentication request is signed by the first user device.

3. A method as claimed in claim 1, wherein the authentication token is displayed by the second user device.

4. A method as claimed in claim 3, wherein the first user device receives the authentication token through a visual input device.

5. A method as claimed in claim 1, wherein the request for the authentication token from the third party server includes a one-time nonce.

6. A method as claimed in claim 5, wherein the application server authenticates the user by transmitting the user identifier and the one-time nonce to the third party server.

7. A method as claimed in claim 6, including the step of the third party server authenticates the user by checking that the one-time nonce has not previously been used.

8. A method as claimed in claim 1, wherein the gateway server and the application server are the same server.

9. A method as claimed in claim 1, wherein the user identifier is generated in accordance with a user identity method, including:
a) the first user device obtaining the user identifier;
b) the first user device generating a public-private key pair;
c) the first user device transmitting a first request, including the user identifier and the public key, to the application server;
d) the application server generating an authentication token associated with the user identifier and transmitting that token for receipt by an address associated with the user;
e) the first user device receiving the authentication token via the address of the user;
f) the first user device transmitting a second request, wherein at least a part of the second request is derived from the authentication token and at least a part of the second request is signed by the private key; and
g) the application server using the public key to verify the request and validate the user identifier as an identity for the user.

10. A method as claimed in claim 9, wherein the application server verifies the authentication request, at least in part, by validating the user identifier within the authentication request.

11. A method as claimed in claim 10, wherein the authentication request is signed by the first user device and wherein the user device signs the authentication request using the private key.

12. A method as claimed in claim 11, wherein the application server verifies the authentication request, at least in part, by using the public key to authenticate the signed request.

13. A method as claimed in claim 1, wherein the user identifier is generated in accordance with a user identity method, including:
a) the first user device transmitting a first request, including a user identifier, to the application server;
b) the application server generating an authentication token associated with the user identifier and transmitting that token for receipt by an address associated with the user;
c) the first user device receiving the authentication token via the address of the user;
d) the first user device transmitting a second request, wherein at least a part of the second request is derived from the authentication token and at least a part of the second request is encrypted; and
e) the application server decrypting the at least part of the second request to verify the request and validate the user identifier as an identity for the user.

14. A method as claimed in claim 1, wherein the second user device requests an authentication token from the third party server via a web-page received from the third party server and displayed within a web-browser on the second user device.

15. A method as claimed in claim 14, wherein, in response to requesting the authentication token, the second user device receives a location for the authentication token from the third party server and requests the authentication token from that location within an overlay within the web-browser.

16. A system for authenticating a user, including:
a gateway server configured to receive a request for an authentication token from a third party server, to generate a transaction ID and to transmit an authentication token to the second user device, wherein the authentication token incorporates the transaction ID;
an application server configured to verify the authentication request and authenticate the user;
a first user device configured to receive the outputted authentication token and to transmit an authentication request to an application server, wherein the request includes the transaction ID extracted from the authentication token and a user identifier; and
a second user device configured to request authentication from a third party server and to output the authentication token.

17. A system as claimed in claim 16, further including a third party server configured to receive a request from authentication from the second user device and to request an authentication token from a gateway server.

18. A system as claimed in claim 16, wherein the third party server is further configured to generate a one-time nonce, and wherein the request for the authentication token includes the one-time nonce.

19. A system as claimed in claim 18, wherein the application server authenticates the user by transmitting the user identifier and the one-time nonce to the third party server.

20. A system as claimed in claim 19, wherein third party server authenticates the user by checking that the one-time nonce has not previously been used.

21. A system as claimed in claim 16, wherein the first user device is further configured to sign the authentication request.

22. A system as claimed in claim 16, wherein the second user device is further configured to display the authentication token.

23. A system as claimed in claim 22, wherein the first user device receives the authentication token through a visual input means.

24. A system as claimed in claim 16, wherein the gateway server and the application server are the same server.

25. A system as claimed in claim 16, wherein the first user device is further configured to obtain a identifier, to generate a public-private key pair, to transmit a first request to a server, wherein the first request includes the identifier and the public key, to receive an authentication token via the address of the user, to transmit a second request to the server, wherein at least a part of the second request is derived from the authentication token and at least a part of the second request is signed by the private key; and the application server is further configured to generate an authentication token associated with the identifier in response to a first request, to transmit the authentication token for receipt by an address associated with the user in response to the second request, to verify the second request using a public key associated with the second request and, when verified, to validate an identifier associated with the second request as the user identifier.

26. A system as claimed in claim 25, wherein the application server verifies the authentication request, at least in part, by validating the user identifier within the authentication request.

27. (canceled)

28. (canceled)

29. A computer readable storage medium having stored therein a computer program executable on a first user device to authenticate a user, the computer program comprising:
code to receive an authentication token from a second user device;
code to extract a transaction ID from the authentication token; and
code to transmit an authentication request to an application server, wherein the request includes the transaction ID extracted from the authentication token and a user identifier.

30. (canceled)
